(19) United States
(12) Patent Application Publication
(10) Pub. No.: US 2015/0281439 A1
(43) Pub. Date: Oct. 1, 2015

(54) METHOD AND SYSTEMS FOR RECALLING COMMUNICATION INFORMATION

(71) Applicant: VONAGE NETWORK LLC, Holmdel, NJ (US)

(72) Inventor: Sagi Dudai, Tel-Aviv (IL)

(73) Assignee: VONAGE NETWORK LLC, Holmdel, NJ (US)

(21) Appl. No.: 14/230,743

(22) Filed: Mar. 31, 2014

(51) Int. Cl. H04M 3/48

(52) U.S. Cl. CPC H04M 3/48

(57) ABSTRACT

Methods and systems for recalling communication information are provided herein. In some embodiments, a method for recalling communication information may include receiving, from a first device, a first recall request to recall at least one of a communication originated from the first device sent to a second device, or a notification associated with the communication originated from the first device sent to the second device, wherein the communication is one of a voice call, a video call, a voicemail message, a video message, a Short Message Service (SMS) message, or a multimedia messaging service (MMS) message, sending a second recall request to the second device, wherein the second recall request includes recall information identifying the at least one communication or notification to be recalled, and receiving a confirmation message from the second device including information regarding the status of the at least one communication or notification.

### BACKGROUND

1. Field

Embodiments of the present invention generally relate to methods and systems for recalling missed call notifications and other types of communications.

2. Description of the Related Art

Typically, people communicate over mobile devices, and rely on notifications provided by the mobile devices to notify them of incoming calls, missed calls, voicemails, text messages or the like. In many instances, the caller may like to speak with his or her friend or associate for a short period of time for an immediate need, and would not like to leave a voicemail, or have the friend or associate call them back. In one example, if the caller happens to be in the friend's area and would like to have lunch with the friend but the friend does not pick up their phone, a return call from the friend at a later time would not be useful. However, in current systems, the friend would see the missed call notification and may call the caller back, resulting in an unnecessary phone call. In other instances, the caller may leave a voicemail or send a text message, but then realize that the message was unnecessary, however, they have no way to recall or recall the communication.

Therefore, there is a need in the art for a method and system for recalling communication information after it has been sent.

### SUMMARY

Methods and systems for recalling communication information are provided herein. In some embodiments, a method for recalling communication information may include receiving, from a first device, a first recall request to recall at least one of a communication originated from the first device sent to a second device, or a notification associated with the communication originated from the first device sent to the second device, wherein the communication is one of a voice call, video call, a voicemail message, a video message, a Short Message Service (SMS) message, or a multimedia messaging service (MMS) message, sending a second recall request to the second device, wherein the second recall request includes recall information identifying the at least one communication or notification to be recalled, and receiving a confirmation message from the second device including information regarding the status of the at least one communication or notification.

In some embodiments, a method for recalling communication information may include providing one or more communication information recall options on a display associated with a first device, receiving a selection of one of the plurality of recall options, and sending, responsive to the selection received, a recall request to recall at least one of a communication sent to a second device, or a notification associated with the communication originated from the first device sent to the second device, wherein the communication is one of a voice call, a video call, a voicemail message, a video message, a Short Message Service (SMS) message, or a multimedia messaging service (MMS) message.

Other and further embodiments of the present invention are described below.

### BRIEF DESCRIPTION OF THE DRAWINGS

So that the manner in which the above recited features of embodiments of the present invention can be understood in detail, a more particular description of embodiments of the present invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for recalling missed call notifications and other types of communications, according to one or more embodiments;

FIGS. 3A and 3B depict a graphical user interface for a telecommunication application for recalling missed call notifications and other types of communications, according to one or more embodiments;

FIGS. 4A and 4B depict flow diagrams of methods for recalling missed call notifications and other types of communications, according to one or more embodiments;

FIG. 5 depicts another method for recalling missed call notifications and other types of communications, according to one or more embodiments; and

FIG. 6 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for recalling communication information. More specifically, embodiments of the present invention facilitate the recall of communication information sent to a called device or voicemail system. In some exemplary embodiments consistent with the present invention, the communication may be a communication between two users including, for example, a text message (e.g., SMS), a missed phone call notification, a voicemail, an instant message, a multi-media message (e.g., multimedia messaging service (MMS) message), or the like. In some embodiments, the communication can be modified by attaching a text message or voice mail to, for example, a missed call notification, a voicemail, or other notifications.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

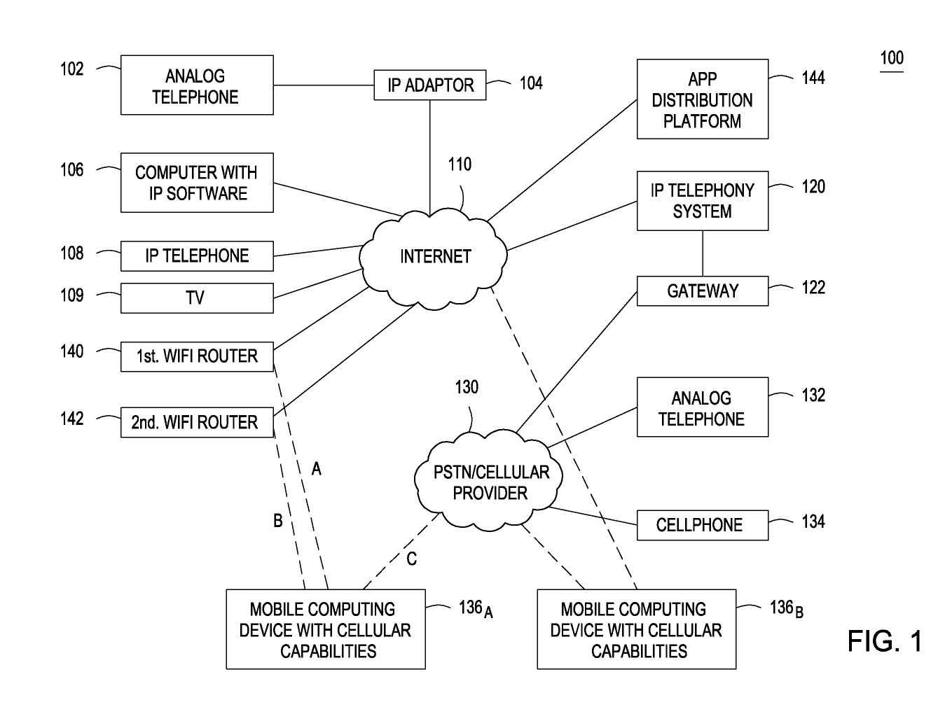

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard. In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail. In some exemplary embodiments described below, mobile computing devices 136A and 136B are on different service provider networks and communications between mobile computing devices 136A and 136B are off-net communications.

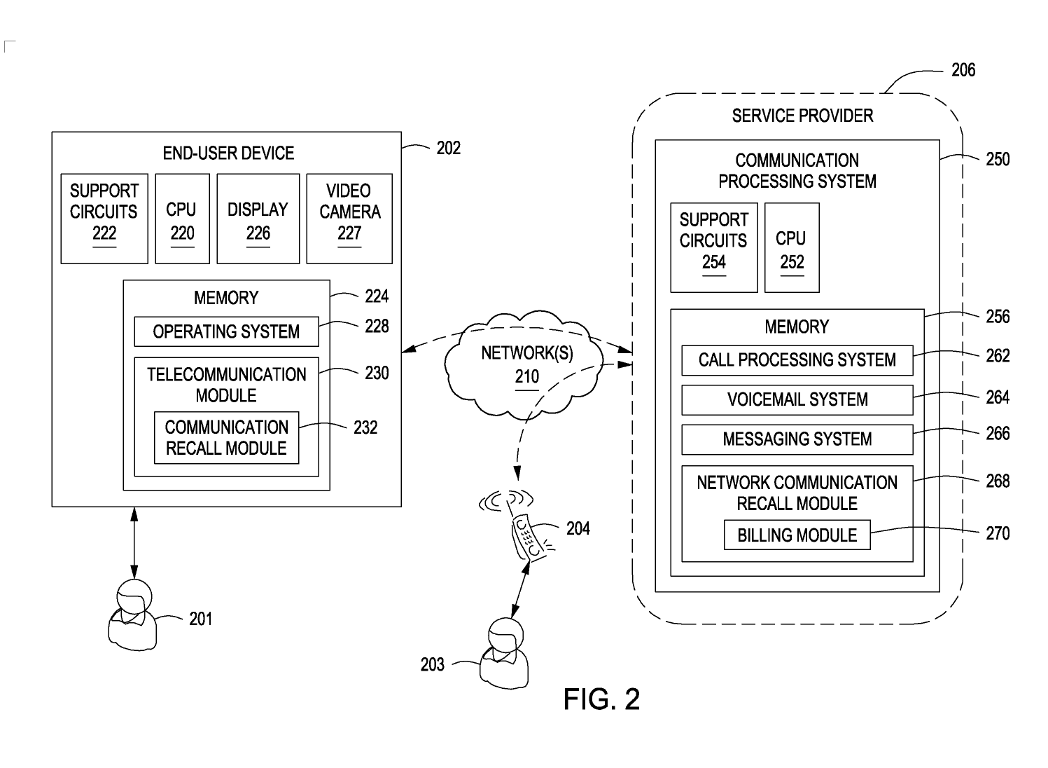

FIG. 2 depicts a block diagram of a system 200 for recalling/modifying missed call notifications and other types of communications in accordance with embodiments presented herein. The system 200 includes at least one telecommunication service provider network 206 that can provide telecommunication services to a plurality of end-user devices (e.g., such as user device 202 and user device 204) via one or more networks 210. Devices 202 and 204 may include analog phone 102, a computer 106 with IP software, IP telephone 108, TV 109 and/or mobile computing device with cellular capabilities 136A, 136B, and the like, as shown in FIG. 1. The telecommunication service provider 206 may include IP telephone system 120 (i.e., a VoIP service provider) or PSTN/cellular provider 130.

For example, in operation a first user 201 of a first mobile device 202 can communicate with a second user 203 of a mobile device 204 over the data network 210. The communication may take the form of a call placed from the first user device 202 to the second user device 204. When user 201 is near the office or home of user 203, user 201 may call user 203 to inquire whether the user 203 is available to have lunch or dinner. If user 203 associated with device 204 misses the call from user 201, a missed call notification is generated on device 204 and displayed by device 204 indicating that user 201 has called. In some embodiments, other call information such as, for example, the time of the call, the caller ID, and the like may also be displayed.

If user 201 no longer desires to speak with the user 203 regarding lunch or dinner (e.g., user 201 has finished eating), the user 201 may wish to have the missed call notification recalled so that the notification doesn't appear on device 204, and thus, user 203 doesn't call user 201 back needlessly. In some embodiments, to recall the missed call notification, user 201 submits a request via a communication recall module 232 of a telecommunication module 230 installed on device 202 to recall the missed call notification that is displayed on the mobile device 204. In some embodiments, the request from communication recall module 232 comprises recall information. The recall information may include, for example, information identifying the at least one communication or notification to be recalled, the type of recall request (e.g., which communications should be recalled) and rules for recall (e.g., how and when the communication should be recalled). For example, the recall information may include information as to whether the recall of a missed call notification should be performed immediately or after a particular period of time, whether a confirmation of the recall is desired, billing information or information used for billing purposes, and the like, as described below in further detail.

A communication processing system 250 of the service provider 206 may include a network communication recall module 268 that processes the recall request and transmits a second request through the data network 210 to the mobile device 204 to remove the communication/notification, either immediately, or after a predetermined period of time. The second recall request includes similar recall information included in the first recall request received (e.g., identifying the at least one communication or notification to be recalled, and the like as described above).

The mobile device 204 receives the request to recall the communication/notification, and removes the missed call from the call list. In some embodiments, the second request to recall the communication/notification is received, processed and performed by a telecommunication app including a communication recall module installed on mobile device 204. In instances where a predetermined time period was included in the original recall request from device 202, either communication recall module 232 or the network communication recall module 268 will delay transmission of the recall request to remove the communication/notification for the predetermined time period. In other embodiments, the communication recall module 232 and network communication recall module 268 may immediately send the request to the mobile device 204, and the receiving device (e.g., device 204) will wait to process the recall request until the predetermined time period has expired.

The communication recall module 232 and/or network communication recall module 268 may send the request as a proprietary Session Initiation Protocol (SIP) header, dual tone multi frequency (DTMF) signaling, a Transmission Control Protocol (TCP) message, User Datagram Protocol (UDP) message, Hypertext Transfer Protocol (HTTP) message, or the like.

In some embodiments SIP proprietary headers could be used to “anchor” or associated the caller's actions to the correct call. In DTMF, a proprietary code may be selected which, when transmitted to a mobile device or landline, causes a communication to be recalled. In some embodiments, the DTMF tone (e.g., such as a DTMF-A, DTMF-B, DTMF-C, DTMF-D tone) may be generated from the telecommunication module 230 and sent over the Real-time Transport Protocol (RTP) stream to the communication processing system 250. The network communication recall module 268 of the communication processing system 250 detects the DTMF tone and processes the action accordingly. For example, upon receiving a DTMF tone indicating a request to recall a communication, the network communication recall module 268 will generate a recall request to be sent to the terminating device to recall the desired communication. In some embodiments, different DTMF tones may be associated with different recall options. For example, a DTMF-A tone may indicate to recall the communication or notification immediately while a DTMF-B tones may indicate to recall the communication or notification after a default time period (e.g., 15 minutes).

In some embodiments, the recall request from device 202 may include a request for a confirmation receipt that confirms that the communication/notification was either successfully recalled from the device 204, or that it could not be recalled. In some embodiments, certain communications may not be recalled if the communication has been viewed/opened/selected on the terminating device (e.g., device 204 in the examples above). In those situations, the confirmation message may inform the user that the communication could not be recalled.

In some embodiments, the user may select to end the call and associate a text or voice mail message with the missed call notification. The communication recall module 232 may generate a communication/notification modification request to modify the notification instead of recalling the communication/notification entirely from the mobile device 204. In at least one embodiment, the user 201 using device 202 is able to associate a text message with a missed call notification on device 204. The text message is then delivered to the device 204 via the data network 110. The text message may be associated with the missed call notification, or may be sent as a separate text message that references the missed call. For example, when user 203 selects a missed call notification that has a text message associated with it, the text message may be displayed (e.g., via a pop-up message, or a link associated with the notification) proximate to the missed call notification. In some embodiments, the associated text message may include envelope information regarding the call attempt made (i.e., date and time of call as the subject of the text message sent) to associate the text with the call notification. In another embodiment, a “push” notification is used to message the user 203. The push notification is a part of a standard notification mechanism provided by Application Programming Interfaces (APIs) of mobile device operating systems such as ANDROID or IOS and the like.

The end-user devices (e.g., device 202 and device 204) comprise a Central Processing Unit (CPU) 220, support circuits 222, memory 224, display device 226, and video camera 227. The CPU 220 may comprise one or more commercially available microprocessors or microcontrollers that facilitate data processing and storage. The various support circuits 222 facilitate the operation of the CPU 220 and include one or more clock circuits, power supplies, cache, input/output circuits, and the like. The memory 224 comprises at least one of Read Only Memory (ROM), Random Access Memory (RAM), disk drive storage, optical storage, removable storage and/or the like. In some embodiments, the memory 224 comprises an operating system 228, and telecommunication module 230 that includes a communication recall module 232.

The telecommunication module 230 may be an Over-the-top (OTT) Voice over internet protocol (VoIP) application that allows a customer to make telephone and video calls over an IP network such as data network 210. The communication recall module 232 allows a user (e.g., user 201) to recall communications originated by the user 201 via device 202, or a notification that was sent as a result of a missed communication originated by the user 201 via device 202. A communication from device 202 to device 204 may be a phone call, a text message, a multimedia messaging service (MMS) message, a voicemail, a video message, or a communication in a media or instant messaging application. The communication recall module 232 can send recall requests to other devices, and receive and process recall requests from other devices for recall of a missed call notification, a text message, a voicemail, and the like.

The operating system (OS) 228 generally manages various computer resources (e.g., network resources, file processors, and/or the like). The operating system 228 is configured to execute operations on one or more hardware and/or software modules, such as Network Interface Cards (NICs), hard disks, virtualization layers, firewalls and/or the like. Examples of the operating system 228 may include, but are not limited to, LINUX, MAC OSX, BSD, UNIX, MICROSOFT WINDOWS, IOS, ANDROID and the like.

The telecommunication service provider network 206 may include a communication processing system 250. In some embodiments, the communication processing system 250 comprises a Central Processing Unit (CPU) 252, support circuits 254, and memory 256. The CPU 252 may comprise one or more commercially available microprocessors or microcontrollers that facilitate data processing and storage. The various support circuits 254 facilitate the operation of the CPU 252 and include one or more clock circuits, power supplies, cache, input/output circuits, and the like. The memory 256 comprises at least one of Read Only Memory (ROM), Random Access Memory (RAM), disk drive storage, optical storage, removable storage and/or the like. In some embodiments, the memory 256 comprises a call processing system 262, voicemail system 264, message system 266, and an optional network communication recall module 268. In some embodiments, the call processing system 262, voicemail system 264, message system 266, and the network communication recall module 268 may be disposed on a single server. In other embodiments, the call processing system 262, voicemail system 264, message system 266, and a network communication recall module 268 may each be separate servers communicatively coupled to each other. In some embodiments, the call processing system 262, voicemail system 264, message system 266, and the network communication recall module 268 may be co-located or may be distributed cloud based services maintained by different entities.

In some embodiments, the call processing system 262 may be a VoIP call processing system that handles VoIP communication requests, or any other type of voice call processing system that can establish voice communication calls. The messaging system 266 may be any system that facilitates the sending and receiving of SMS and MMS messages, and the like.

The call processing system 262 may receive a request to recall from an end-user device (e.g., device 202 and/or 204). In some embodiments, the call processing system 262 may forward a communication recall request received from device 202, for example, to device 204 to recall the desired notification/communication. In other embodiments, the network communication recall module 268 may process the recall request and send an appropriate recall request to one or more of the voicemail system 264, message system 266, or to another device (e.g., device 204) to recall the desired notification/communication.

In some embodiments, the network communication recall module 268 may further include a billing module 270. The billing module 270 may be invoked by the network communication recall module 268 after a user requests recall of a communication. For example, a service provider 206 may enable the billing module 270, charging for the recall service according to a cost structure. After recall of a communication, a billing notification is sent to the service provider 206 to charge the user (e.g., user 201). In other instances, the number of recalls is recorded locally or remotely, and the charge is reflected in a user's periodic bill. The service provider may capture the number of communications recalled, the types of communications recalled, the timing of most recalls, users who recall more frequently, or the like, in order to generate statistical business reports.

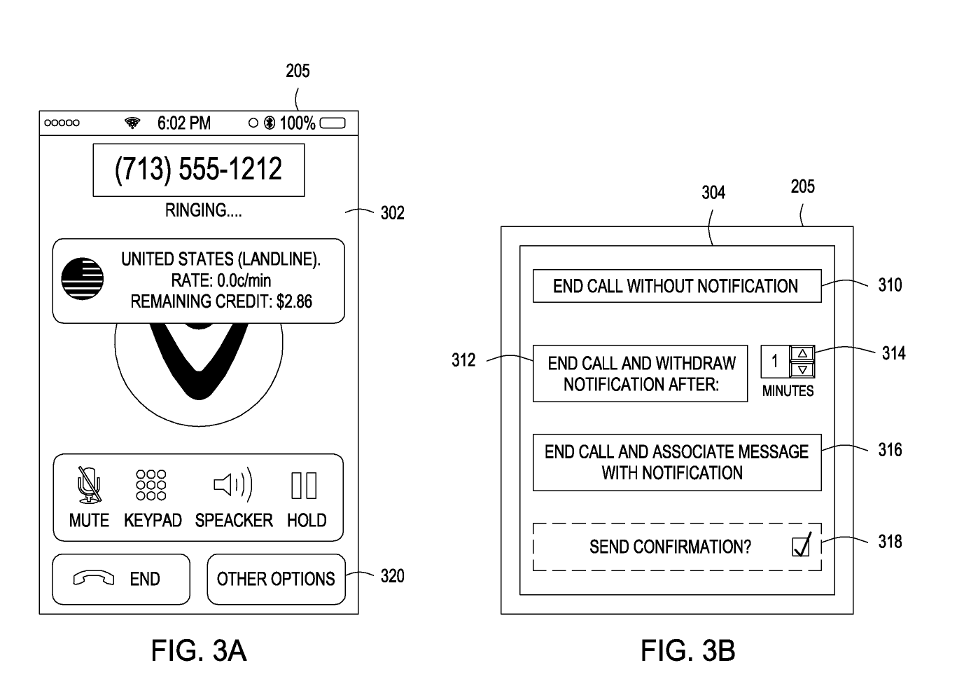

Referring to FIGS. 3A and 3B, an exemplary user interface for telecommunication module 230 is shown on display 226 of device 202 to recall communication and/or missed call notifications, according to one or more embodiments. In the example shown in FIG. 3A, screen 302 includes an object 320, which when selected, provides access to one or more recall options on screen 304 of FIG. 3B. For example, when making a call from device 202 to device 204 via telecommunication module 230, while the call is in progress of being established (e.g., ringing), user 201 may select object 320 on the display of device 202. If such a selection is received by the telecommunication module 230, a recall options screen 304 is displayed as shown and discussed in further detail with respect to FIG. 3B. The recall options may include ending the call and recalling the missed call notification entirely, ending the call and recalling the missed call notification after a specified period of time, or ending the call and associating a text message or a voice mail with the missed call notification. Other recall options (not shown) may include recall of a previous voice mail left, or an SMS or MMS message left. The preferences from screen 304 may be saved locally on the device 202, or saved remotely on the communication processing system 250. The recall options may include a button/object 310 if the user wishes to end the call and to have the communication notification either suppressed, or removed entirely, a button/object 312 if the user wishes to remove the communication notification after a predetermined period of time, where the period of time is indicated via input box 314, and a button/object 316 to end the call and associated a message with the missed call notification. Placement of buttons/objects on screen 304 could be customized by the user. In some embodiments, an additional recall confirmation option 318 may be provided on screen 304. Selection of the recall confirmation option 318 includes a request for a confirmation message confirming that the missed call notification was recalled from the device 204. As described above, the confirmation request may be included in the recall information of the recall request sent. In some embodiments, certain communications may not be recalled if the communication has been viewed/opened/selected on the terminating device (e.g., device 204 in the examples above). In those situations, the confirmation message may inform the use that the communication could not be recalled.

Although FIG. 3 shows options for recalling a communication while a call attempt is in progress, in some embodiments, recalling a communication may occur after an attempted call has ended or after a voice mail has been left. For example, in some embodiments, a user may be able to select the attempted call from a call log. Selection of the call from the call log may display recall options for that call attempt. In some embodiments, those options may include recalling a missed call notification associated with the call attempt selected either immediately after a predetermined period of time, associating a text message with the missed call notification associated with the call attempt selected, or recalling a voicemail associated with the missed call notification associated with the call attempt selected.

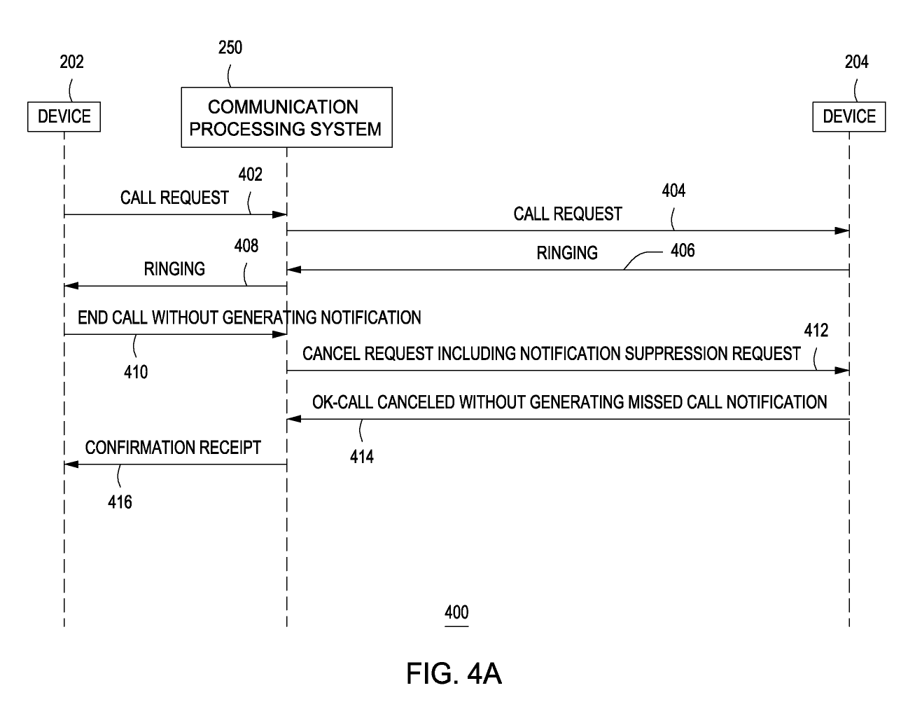

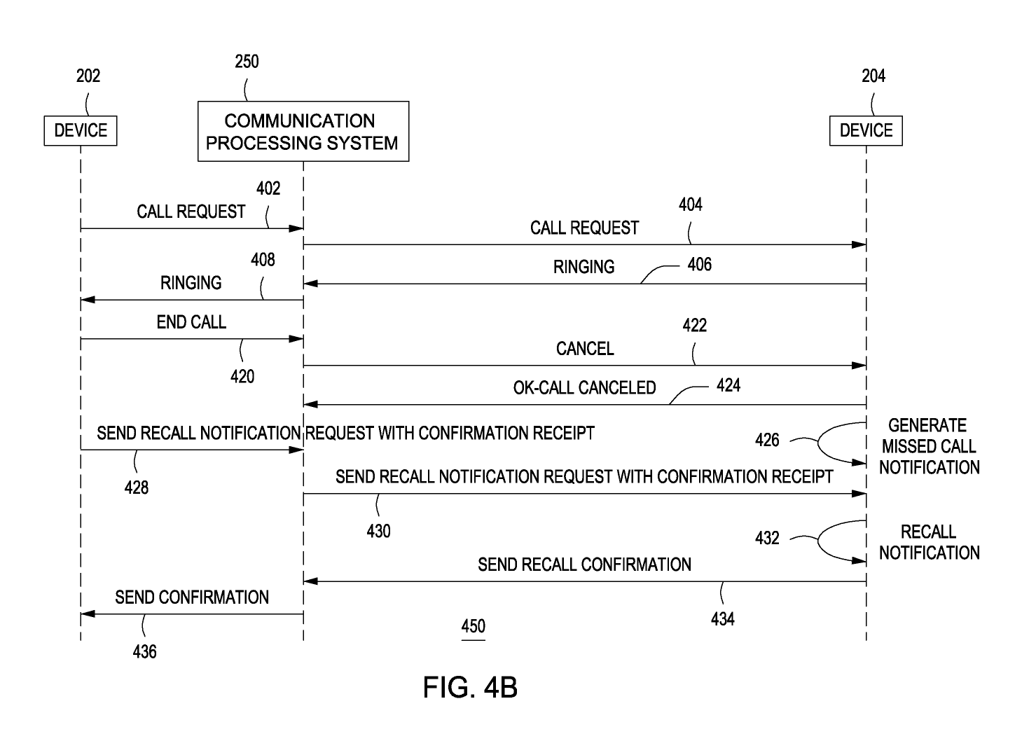

FIG. 4A depicts a method 400 for recalling communications and/or missed call notifications, according to one or more embodiments of the present disclosure. The method 400 may be performed using one or more of the modules described above with respect to FIG. 2 and the user interface of FIGS. 3A and 3B. In FIG. 4A, user 201 of device 202 may initiate a call with user 203 of device 204 via telecommunication module 230 at 402. A call request 401 may be sent from device 202 to the communication processing system 250 to establish the call. In a VoIP network, the call request 401 oftentimes takes the form of a Session Initiation Protocol (SIP) INVITE message sent from device 202 to communication processing system 250. In a VoIP network, the communication processing system 250 may be, for example, a SIP Proxy Network. The details and functionality of SIP can be found in the Internet Engineering Task Force (IETF) Request for Comments (RFC) Paper No. 3261 entitled, “SIP: Session Initiation Protocol” herein incorporated in its entirety by reference.

At 404, the call request may be sent from the call processing system 262 of communication processing system 250 to device 204 to establish the call between device 202 and device 204. Device 204 may respond to the call processing system 262 with an acknowledgement message at 406, such as for example, an SIP 180 Ringing message indicating that a call is attempting to be established. The acknowledgement message may be forwarded to device 202 at 408 to let user 201 of device 202 know that the call is in progress. As the call is in progress, device 202 may receive an instruction/selection from the user to end the call without generating a missed call notification. For example, in some embodiments, the user 201 may first select display object 320 on screen 302, and then display object 310 on screen 304. The selection of display object 310 will generate a recall request to end the call without leaving a missed call notification. The recall request is sent to communication processing system 250 at 410. The network communication recall module 268 may process the recall request and send/forward the recall request to device 204 at 412. Upon receipt of the request, device 204 will end the call and will not generate a missed call notification. In some embodiments, device 204 will process the request using a communication recall module of a telecommunication module (e.g., similar or the same as communication recall module 232 of a telecommunication module 230) installed on device 204. At 414, the device 204 may send an acknowledgement message back to the communication processing system 250 indicating that the call was cancelled without generating the missed call notification. In some embodiments, if requested by the user 201, a confirmation receipt including information that the call was cancelled without generating the missed call notification is sent to device 202 at 416.

FIG. 4B depicts a method 450 for recalling communications and/or missed call notifications after the call has ended, according to one or more embodiments of the present disclosure. Steps 402, 404, 406 and 408 are similar to those described above with respect to FIG. 4A. At 420, the user 201 may end the call be simply hanging up the phone or selection a display object to end the call normally. At 422 the call cancelation message is sent to device 204 and an acknowledgement that the call was cancel is received at 424. At 426, device 204 will generate a missed call notification on device 204 to alert user 203 of device 204 that a call from device 202 was missed.

At a later time, device 202 may receive an instruction/selection from the user 201 to recall the missed call notification left on device 204 with a request for confirmation receipt. At 428, the recall request is sent to communication processing system 250 and forwarded on to device 204 at 430. Upon receipt of the recall request, if the user 203 has not already viewed or selected the call notification, device 204 will recall the missed call notification at 432. The device 204 will send a recall confirmation at 434 which will be forwarded to device 202 at 436.

Although discussed above with respect to recalling a missed call notification on an end user device (e.g., device 204), similar communication may occur to remove voicemail message notifications, SMS/MMS messages, and the like from device 204. In addition, similar communication may occur between user device 202 and voicemail system 264/message system 266 to remove voicemail messages and SMS/MMS messages, respectively.

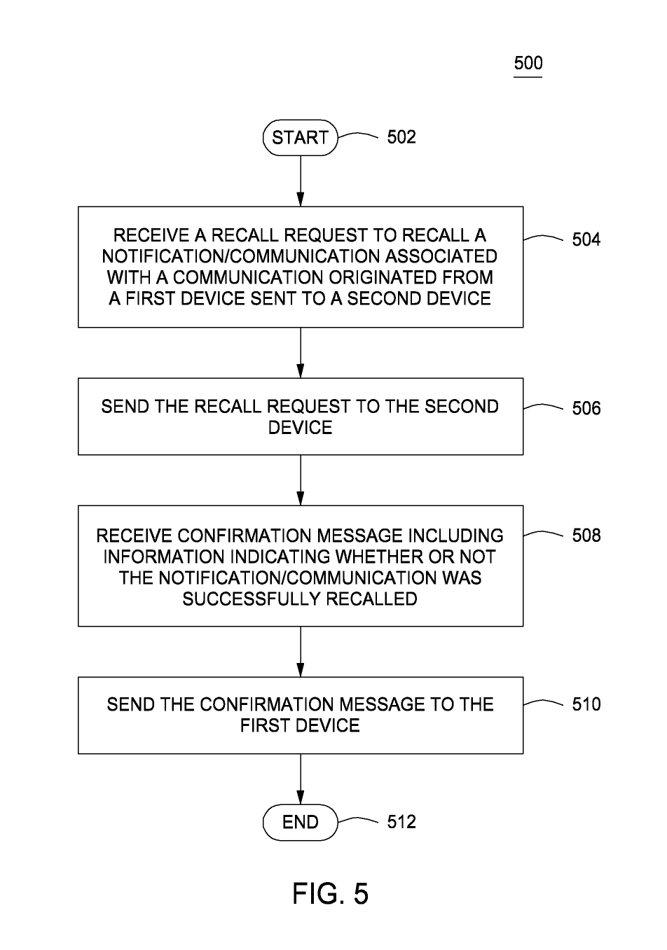

FIG. 5 depicts another method 500 for recalling communications and/or missed call notifications, according to one or more embodiments of the present disclosure. The method 500 begins at 502 and proceeds to 504 where a recall request is received. The recall request includes recall information to recall a notification/communication associated with a communication originated from a first device being sent to a second device. At 506, the recall request is sent to a second device. In some embodiments, the second device may be an end-user device (e.g., device 204), a voicemail system (e.g., voicemail system 264), a messaging system (e.g., messaging system 266), and the like. At 508, a confirmation may be received responsive to the recall request sent. The confirmation message may include information indicating whether or not the notification/communication was successfully recalled. At 510, the confirmation message is sent to the first device. The method 500 ends at 512.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

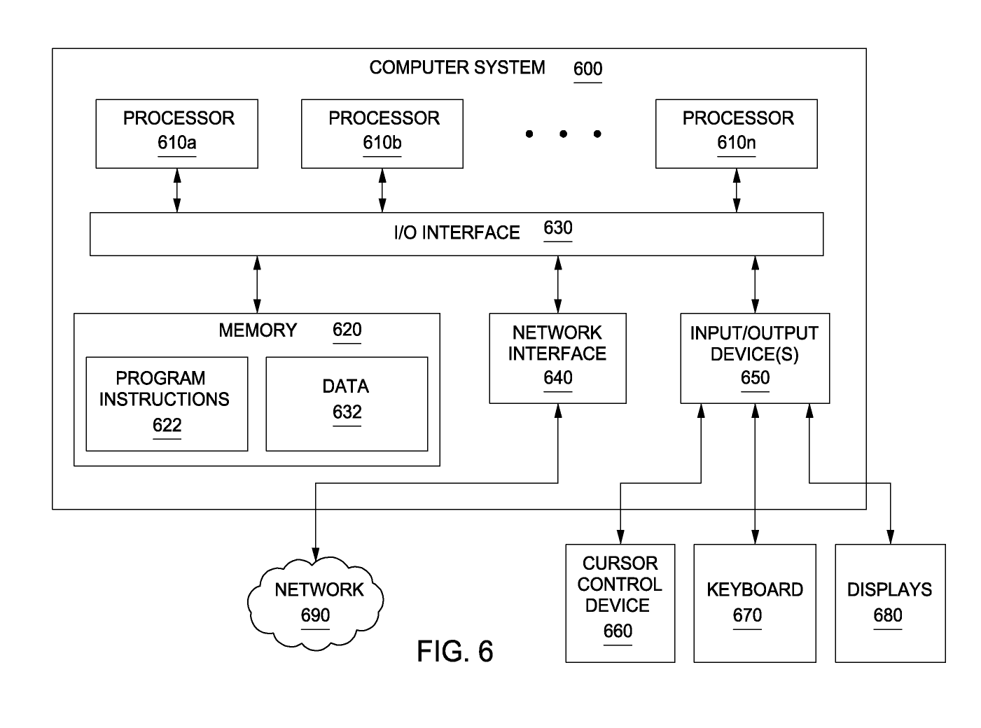

FIG. 6 depicts a computer system 600 that can be utilized in various embodiments of the present invention to implement the computer and/or the display, according to one or more embodiments.

Various embodiments of method and apparatus for routing calls based upon internal network conditions and/or external carrier network information, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 400, 450, and 500 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated in FIGS. 4A, 4B and 5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for recalling communication information, comprising:
receiving, from a first device, a first recall request to recall at least one of a communication originated from the first device sent to a second device, or a notification associated with the communication originated from the first device sent to the second device, wherein the communication is one of a voice call, a video call, a voicemail message, a video message, a Short Message Service (SMS) message, or a multimedia messaging service (MMS) message; and
sending a second recall request to the second device, wherein the second recall request includes recall information identifying the at least one communication or notification to be recalled.

2. The computer-implemented method of claim 1, wherein the first recall request is a Session Initiation Protocol (SIP) message including recall information identifying the at least one communication or notification to be recalled.

3. The computer-implemented method of claim 1, wherein the first recall request is a dual tone multi frequency (DTMF) tone.

4. The computer-implemented method of claim 1, wherein the first recall request is received while a voice call between the first device and the second device is being established.

5. The computer-implemented method of claim 1, wherein the second recall request is sent while a voice call between the first device and the second device is being established.

6. The computer-implemented method of claim 5, wherein the first recall request and the second recall request include information to prevent a missed-call notification from being generated on the second device.

7. The computer-implemented method of claim 1, wherein the first recall request is received after a voice call attempt between the first device and the second device has failed or been canceled, and wherein the first recall request includes a request to recall a missed-call notification on the second device.

8. The computer-implemented method of claim 1, further comprising:
receiving a confirmation message from the second device including information regarding a status of the at least one communication or notification.

9. The computer-implemented method of claim 8, wherein the first recall request includes a confirmation receipt request, the method further comprising:
sending the confirmation message to the first device responsive to the first recall request received including the confirmation receipt request.

10. The computer-implemented method of claim 9, wherein the confirmation message indicates that the at least one communication or notification was successfully recalled.

11. The computer-implemented method of claim 9, wherein the confirmation message indicates that the at least one communication or notification could not be recalled.

12. The computer-implemented method of claim 1, wherein the first recall request includes an indication to recall the at least one communication or notification immediately.

13. The computer-implemented method of claim 1, wherein the first recall request includes an indication to recall the at least one communication or notification after an expiration of a predetermined time period.

14. The computer-implemented method of claim 1, further comprising:
sending billing information to a telecommunication service provider that provides a communication information recall service, wherein the billing information includes at least one of a number of communications and notifications recalled, types of communications and notifications recalled, or a time of each recall request.

15. The computer-implemented method of claim 1, wherein the second device is an end-user mobile device.

16. The computer-implemented method of claim 1, wherein the second device is a voicemail system or a message system.

17. A computer-implemented method for recalling communication information, comprising:
providing one or more communication information recall options on a display associated with a first device;
receiving a selection of one of the one or more communication information recall options; and
sending, responsive to the selection received, a recall request to recall at least one of a communication sent to a second device, or a notification associated with the communication from the first device sent to the second device, wherein the communication is one of a voice call, a video call, a voicemail message, a video message, a Short Message Service (SMS) message, or a multimedia messaging service (MMS) message.

18. The computer-implemented method of claim 17, wherein the one or more communication information recall options include at least one of (a) ending a voice call attempt and send a request to suppress a missed call notification on the second device, (b) sending a request to recall a missed call notification on the second device after a predetermined period of time, (c) specifying a predetermined period of time after which a missed-called notification should be removed, (d) requesting a recall conformation receipt, or (e) associating a text message with a missed call notification.

19. The computer-implemented method of claim 17, wherein the recall request is a Session Initiation Protocol (SIP) message including recall information identifying the at least one communication or notification to be recalled.

20. The computer-implemented method of claim 17, wherein the recall request is a dual tone multi frequency (DTMF) tone.
